(19) United States
(12) Patent Application Publication
(10) Pub. No.: US 2025/0307725 A1
(43) Pub. Date: Oct. 2, 2025

(54) Private Drive Share Passenger Transportation System

(71) Applicant: Peter John Barry, RIVERHEAD, NY (US)

(72) Inventor: Peter John Barry, RIVERHEAD, NY (US)

(21) Appl. No.: 18/619,765

(22) Filed: Mar. 28, 2024

(51) Int. Cl. G06Q 10/02; G06Q 50/47

(52) U.S. Cl. CPC G06Q 10/025; G06Q 50/47

(57) ABSTRACT

THE PRIVATE DRIVESHARE PASSENGER TRANSPORTATION SYSTEM CREATES A NEW SUB-INDUSTRY WITHIN THE PASSENGER TRANSPORTATION SECTOR. CAB COMPANIES THRIVE ON LONG DISTANCE RIDES WHICH LIMITS AVAILABILITY FOR SHORTER RIDE REQUESTS. RIDE-SHARE ENTITIES LIKE UBER/LYFT LACK THE PERSONAL TOUCH THAT A PRIVATE DRIVESHARE SERVICE PROVIDES AND IT IS MORE THAN LIKELY A DIFFERENT DRIVER AND DIFFERENT VEHICLE FOR EVERY RIDE SCHEDULED WITHIN A GIVEN DAY. PRIVATE DRIVE SHARE CLIENTS CAN STORE ITEMS IN THE BACK OF THE VEHICLE BETWEEN RIDES. PRIVATE CAR SERVICES ARE IN A WHOLE DIFFERENT CLASS OF COSTS THAT LIMITS THE AVERAGE CONSUMER FROM HIRING THEM. THIS SYSTEM ALLOWS AN AFFORDABLE OPTION FOR CLIENTS AND ALSO PROVIDES THE OPPORTUNITY FOR THE DRIVER TO MAXIMIZE THEIR POTENTIAL IN ANY GIVEN DAY. WHILE THE PRIVATE DRIVER IS THE LEAST AFFORDABLE FOR THE CONSUMER, LIMITING THE MARKET FOR THOSE COMPANIES TO WEALTHY INDIVIDUALS ONLY.

The substitute Specification below with the newly included claim, previously sent separately, has no new information, but rather further describes the invention.

### SPECIFICATION

TITLE OF THE INVENTION: The Private Driveshare Passenger Transportation System CROSS REFERENCE TO RELATED APPLICATIONS: Please accept the enclosed pages 1-6, the certification of micro entity status, and the personal check made out for the remaining balance due based off of the conversation made by Michelle on Jul. 25, 2024 as an addition to existing pending application: 18619765.

STATEMENT REGARDING FEDERALLY SPONSORED RESEARCH OR DEVELOPMENT: The sole inventor, Peter J. Barry, received no federal sponsorship for the research involved in, nor for the development of The Private Driveshare Passenger Transportation System.

Zero Joint-Inventors have been involved as part of the research and development of The Private Driveshare Passenger Transportation System. The Private Driveshare Passenger Transportation System was invented by one person. That person is Peter John Andrew Barry, born on Oct. 22, 1991, currently residing in Riverhead, New York, 11901, The United States of America with a transportation business out of Southold, New York 11971, The United States of America.

### BACKGROUND OF THE INVENTION

As an entrepreneur running an independent passenger transportation service for the last two years, there have been two main options for someone to call in looking for multiple local rides to multiple destinations within a day. The first option was to offer an hourly service, where the vehicle and driver were ready to drive a group at any time within a certain timeframe at a costly amount compared to the second option. The second option was to offer a by-the-ride service, which is not always ideal from an independent driver's side of things.

The Private Driveshare Passenger Transportation System provides the car services of. the future to provide a third option.

### FIELD OF THE INVENTION: PASSENGER TRANSPORTATION

### BRIEF SUMMARY OF THE INVENTION

The Private Driveshare Passenger Transportation System is a system for passenger transportation services to provide, and for consumers to enjoy, a new experience offered by passenger transportation services. It is to provide the consumer with an experience similar to hiring a private car service and driver, all to themselves, while also sharing said driver and vehicle with other groups of passengers. This is completed by way of achieving a status to control a desired timeframe by approving scheduling rides around their own, and maintaining a positive experience for all in an organized manner.

### DETAILED DESCRIPTION OF THE INVENTION

Please note, going forward, “The Private Driveshare Passenger Transportation System” shall be also referred to and also be known as “Driveshare”, or “Private Driveshare” as a description of The System itself, a description of the specified customer electing to go with that service in an example, as well as the future licensed operating entity (entities) providing said service in the future.

The process is comprised of the following example:

CUSTOMER ONE calls in. They want to plan a day and have no idea what the plan is nor do they have any interest in making an itinerary. They should be offered the hourly service quote first but also let them know there is a less expensive quote. The three important details required to schedule either service are the 1. Origin Location (the address of the original pick up and final drop off location) 2. The Timeframe of the desired service and 3. The desired destinations in the area.

In this example, CUSTOMER ONE does not want to pay the hourly price and elects to put the deposit down for 10 hours, from 1:00 PM to 11:00 PM, to be the day's designated “Private Driveshare” customer.

CUSTOMER TWO calls in and knows the exact times they need service with the appropriate amount of passengers for the same date and their request falls within the timeframe of CUSTOMER ONE's reserved timeframe. Let us say CUSTOMER TWO requests a ride at 2:00 PM and a ride at 5:00 PM. CUSTOMER ONE has the ability to approve of those reservation requests made by CUSTOMER TWO.

CUSTOMER ONE pays for their timeframe of reserving the day and also pays for the rides they end up receiving.

The cost for rides are quoted at the same time the reservation deposits are made, however, based on “The Private Driveshare” service's operation, the payment for the actual rides can be made upon completion of the actual day's service.

The Private Driveshare Passenger Transportation System allows CUSTOMER ONE to reject CUSTOMER TWO's request. The information would be provided to CUSTOMER ONE regarding an approximation for how long the other group will be using the service or how long the service could be approximately away from them.

Once CUSTOMER ONE accepts an outside request, it's locked in. CUSTOMER TWO has peace of mind that those exact pickup times are reserved for them and CUSTOMER ONE knows they have the time outside of those rides until another request comes in. CUSTOMER ONE cannot go back to remove CUSTOMER TWO's reservations after they previously approved it.

Along with that control that is obtained with CUSTOMER ONE's deposit, also requires CUSTOMER ONE to be timely with a response to the outside requests coming in. It is possible CUSTOMER ONE is refunded and forfeits their reservation and status as the designated “Private Driveshare” Customer if they are not able to communicate with the servicing company in a timely manner. That timeframe should be discussed prior to accepting the deposit from CUSTOMER ONE as well.

If CUSTOMER ONE forfeits their status with a delayed response, exceeding the timeframe disclosed by the “Private Driveshare” service, they are refunded and release the “Driveshare” service to erase any reservations previously made and potentially declare a new “Private Driveshare” customer. The change of that status from one party to another is based on a new deposit coming in after a timeframe stated has surpassed.

CUSTOMER ONE is only refunded by the licensed “Private Driveshare” entity with the receipt of a deposit from CUSTOMER TWO, or potentially another group of people looking for service that date or during that timeframe.

CUSTOMER TWO has two options when CUSTOMER ONE is not responding and the time limit for CUSTOMER ONE has run up. 1. Elect to be put “on the line” where CUSTOMER ONE is still in control and no deposit is offered by CUSTOMER TWO, OR 2. Pay a deposit for their desired timeframe similar to CUSTOMER ONE and become the “Private Driveshare” initiating a refund to CUSTOMER ONE.

To be “on the line” is essentially putting their information down (pick up location, desired destinations and times) as a possibility to schedule the rides very much closer to the date and time of the service, when it's needed. It does not necessarily mean the plan will work out, but as a last minute mutual benefit for both people, the service can be considered a solid backup for their plans, until that group is otherwise notified that it is definitely not a possibility.

CUSTOMER ONE calls back, very late and knows the refund means they have lost their reservation status. They are now willing to make a plan for the day, understanding they received a refund and no longer are in control for the hours CUSTOMER TWO reserved. They request rides around CUSTOMER TWO's schedule and also request to be reserved as “Private Driveshare” customers from 5:00 PM-9:00 PM, with a plan, and it would be up to CUSTOMER TWO to approve both the rides within their timeframe as well as colliding the timeframes from theirs to a new party's (having 1:00 PM-5:00 PM and a new party requesting a start time of 5:00 PM requires CUSTOMER TWO's approval).

1. Private Driveshare Passenger Transportation System and the future licensing and control of said licensing to entrepreneurs, approved to provide the services of providing the unique experience to the consumer comprised of one special consumer seeking a multiple destination day of leisure, with the same driver(s) and the same vehicle(s), willing to share that (those) driver(s) with other parties on the special consumer's terms, within a specified timeframe of a specified date.
